(19) United States
(12) Patent Application Publication
(10) Pub. No.: US 2011/0163918 A1
(43) Pub. Date: Jul. 7, 2011

(54) Antenna Device For Reducing Specific Absorption Rate

(76) Inventors: Yu-Yuan Wu, Taipei (TW); Hung-Jen Chen, Taipei (TW); Chung-Wen Yang, Taipei (TW)

(21) Appl. No.: 12/683,434

(22) Filed: Jan. 7, 2010

(51) Int. Cl. H01Q 9/04; H01Q 1/38

(52) U.S. Cl. 343/700 MS

(57) ABSTRACT

An antenna device includes a main body. The main body has a first radiator which has a first radiating portion, a third radiating portion, a second radiating portion connected with the first radiating portion and the third radiating portion to show a door shape, a fourth radiating portion extended outwards from the third radiating portion, and a fifth radiating portion extended downwardly from the third radiating portion, and stretched towards the same side of the third radiating portion as the second radiating portion, and a second radiator extended toward the third radiating portion from the first radiating portion. A feeding portion and a grounding portion are extended downwards from the second radiator side by side. A resonance element has an elongated first resonating portion spaced from the main body, and a second resonating portion extended perpendicularly from an end of the first resonating portion away from the main body.

### BACKGROUND OF THE INVENTION

1. Field of the Invention

The present invention relates to an antenna, and more specifically to an antenna device for reducing the specific absorption rate.

2. The Related Art

Wireless communication has become extremely popular with the use of cellular telephones and other wireless devices. However, problems have arisen concerning the possibility of harmful effects of electromagnetic energy on the human body inasmuch as handheld radios, cellular telephones and other portable wireless communication devices do emit electromagnetic energy. Many studies have been conducted to closely examine the effects of electromagnetic energy on the human body to determine a safe level of exposure and how to accurately measure the level. In conjunction with this, there have been some attempts to move the source of electromagnetic energy away from the body by means of the antenna location or design. In addition, with the portable wireless communication devices developing toward the miniaturization, the space for receiving the antenna in the portable wireless communication device correspondingly decreases. As a result, it is harmful and undesirable to increases the specific absorption rate (SAR) of the antenna for the sake of raising the efficiency of the antenna, and reducing the voltage standing wave ratio.

### SUMMARY OF THE INVENTION

An object of the invention is to provide an antenna device for reducing the specific absorption rate. The antenna device connected to a circuit board includes a main body and a resonance element. The main body has a first radiator which has a first radiating portion, a third radiating portion abreast of the first radiating portion, an elongated second radiating portion connected with opposite ends of the first radiating portion and the third radiating portion to show a substantially door shape, a fourth radiating portion extended outwards from a side of the third radiating portion opposite to the second radiating portion, and a fifth radiating portion extended downwardly from a free end of the third radiating portion, and stretched towards the same side of the third radiating portion as the second radiating portion, and a second radiator of strip shape extended toward the third radiating portion from an end of the first radiating portion opposite to the second radiating portion. The second radiator extends beyond a free end of the fifth radiating portion and is spaced from the third radiating portion and the fifth radiating portion. A feeding portion and a grounding portion are extended downwards from an end of a side of the second radiator opposite to the first radiating portion side by side, and away from the fifth radiating portion, for being connected with an antenna circuit and a grounding circuit of the circuit board, respectively. The resonance element has an elongated first resonating portion spaced from the main body with a predetermined distance, and a second resonating portion extended perpendicularly from an end of the first resonating portion away from the main body, for being connected with the grounding circuit of the circuit board.

As described above, the antenna device is capable of transmitting the signals from the frequency bands ranging from 880 MHz to 915 MHz, and 1710 MHz to 1785 MHz, and has an excellent performance of operation at wireless communication. Meanwhile, the antenna device is provided with the simple resonance element. The resonance element is capable of resonating with the signals from the frequency band ranging from 880 MHz to 915 MHz, which decreases the SAR values of the antenna device, consequently, for reducing the harm to the users when the users use the portable electronic device.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view illustrating the structure of an antenna device of an embodiment in accordance with the present invention;

FIG. 2 is a perspective view illustrating the antenna device of FIG. 1 mounted to a circuit board;

FIG. 3 shows a Voltage Standing Wave Ratio (VSWR) test chart of the antenna device shown in FIG. 1;

FIG. 4 is a table showing the specific absorption rate of the antenna device shown in FIG. 1; and

FIG. 5 is a table showing the specific absorption rate of a conventional antenna.

### DETAILED DESCRIPTION OF THE EMBODIMENT

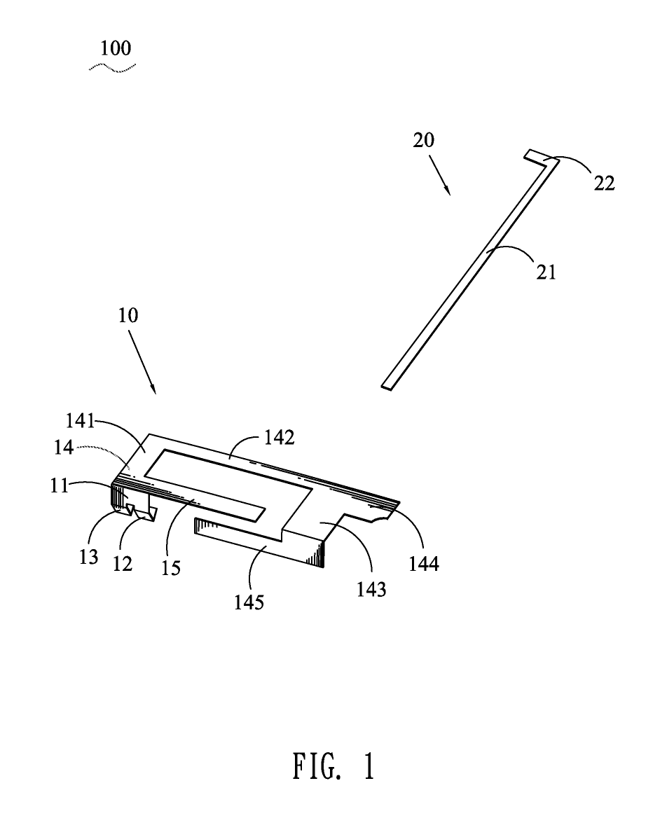

With Reference to FIG. 1, an embodiment of an antenna device 100 according to the present invention is shown. The antenna device 100, which is punched and bent by a metal plate, includes a main element 10 and a resonance element 20 separated from the main element 10. The main element 10 has a first radiator 14. The first radiator 14 has a rectangular first radiating portion 141, a rectangular third radiating portion 143 disposed abreast of the first radiating portion 141, and an elongated second radiating portion 142 connected with opposite ends of facing long sides of the first radiating portion 141 and the third radiating portion 143 to show a substantially door shape. An outer side of the third radiating portion 143, opposite to the second radiating portion 142, has an end extended back to the second radiating portion 142 to form a fourth radiating portion 144. The fourth radiating portion 144 is substantially square and has an outer side flush with an outer side of the second radiating portion 142. A fifth radiating portion 145 is extended perpendicularly and downwardly from a free end of the third radiating portion 143 with a predetermined distance, and stretched towards the same side of the third radiating portion 143 as the second radiating portion 142.

The first radiating portion 141 has an end opposite to the second radiating portion 142 extended towards the third radiating portion 143 to form a second radiator 15. The elongated second radiator 15 extends beyond a free end of the fifth radiating portion 145 and is spaced away from the third radiating portion 143 and the fifth radiating portion 145. A connecting portion 11 is extended downwardly from an end of an outer side of the second radiator 15 away from the third radiating portion 143. The connecting portion 11 is of substantially rectangular shape. Two ends of a bottom side of the connecting portion 11 are extended downwardly and deflected inwardly, and then bent obliquely and upwardly to form a feeding portion 12 and a grounding portion 13. The feeding portion 12 and the grounding portion 13 are substantially V-shaped and spaced from each other. Herein, the first radiating portion 141, the second radiating portion 142, the third radiating portion 143, the fourth radiating portion 144 and the second radiator 15 are disposed at the same plane.

The resonance element 20 of substantially L shape has an elongated first resonating portion 21, and a second resonating portion 22 extended perpendicularly from an end of a long side of the first resonating portion 21. The second resonating portion 22 is a short strip shape. In this embodiment, the resonance element 20 is made of copper foil.

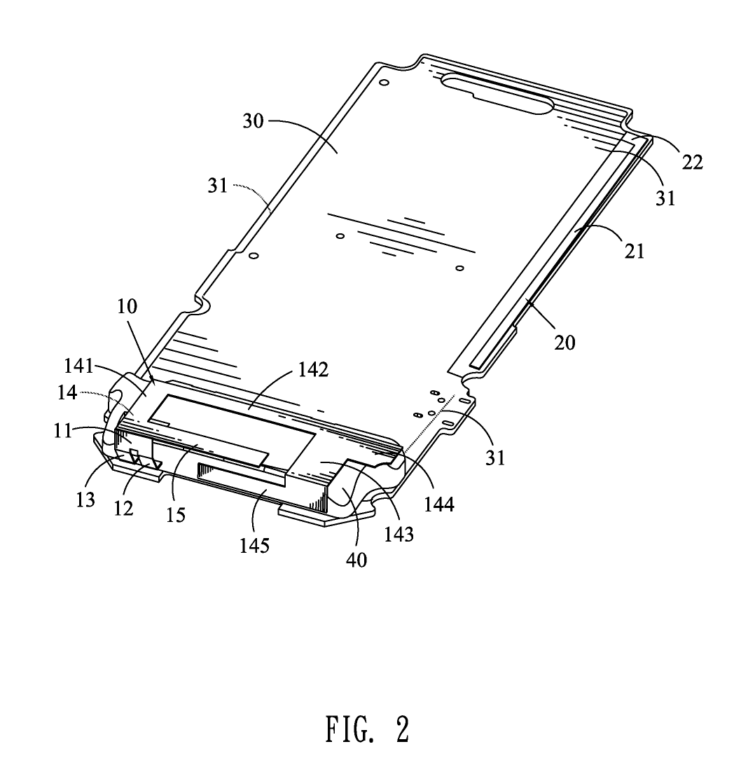

Please refer to FIG. 2, the main element 10 is mounted to a support 40 which is laid on a circuit board 30. Herein, the circuit board 30 is substantially rectangular, and the support 40 is placed at a front end of the circuit board 30. The first radiating portion 141, the second radiating portion 142, the third radiating portion 143, the fourth radiating portion 144 and the second radiator 15 are located on a top surface of the support 40. The fifth radiating portion 145 is attached to a front surface of the support 40. The feeding portion 12 and the grounding portion 13 are disposed frontward of the support 40. The feeding portion 12 is electrically connected with an antenna circuit (not shown) of the circuit board 30. The grounding portion 13 is electrically connected with a grounding circuit 31 of the circuit board 30. Herein, the feeding portion and the grounding portion can be connected to the circuit board in other ways, for example, the cables are provided to connect the feeding portion and the grounding portion with the circuit board. The resonance element 20 is placed on a long side of the circuit board 30 where the fourth radiating portion 144 is located. The first resonating portion 21 extends along the long side of the circuit board 30 and is spaced away from the fourth radiating portion 144 with a predetermined distance. The second resonating portion 22 is placed away from the fourth radiating portion 144, and connects with the grounding circuit 31 of the circuit board 30. Herein, the resonance element can also be mounted to other components of a portable electronic device, such as an inner surface of a cover of the portable electronic device.

When the antenna device 100 operates at wireless communication, a current is fed from the feeding portion 12, runs through the connecting portion 11 and reaches the second radiator 15 to gain a total electrical length corresponding to a quarter of wavelength of the global system for mobile communication (GSM) 900, for receiving and sending signals from the frequency band ranging from 880 MHz to 915 MHz. The current is fed from the feeding portion 12, runs through the connecting portion 11 and reaches the first radiator 14 to generate a total electrical length corresponding to a quarter of wavelength of the digital cellular system (DCS) 1800, for receiving and sending signals from the frequency band ranging from 1710 MHz to 1785 MHz. The total electrical length of the resonance element 20 corresponds to one quarter of wavelength of the GSM 900 and is capable of resonating with the signals from the frequency band ranging from 880 MHz to 915 MHz.

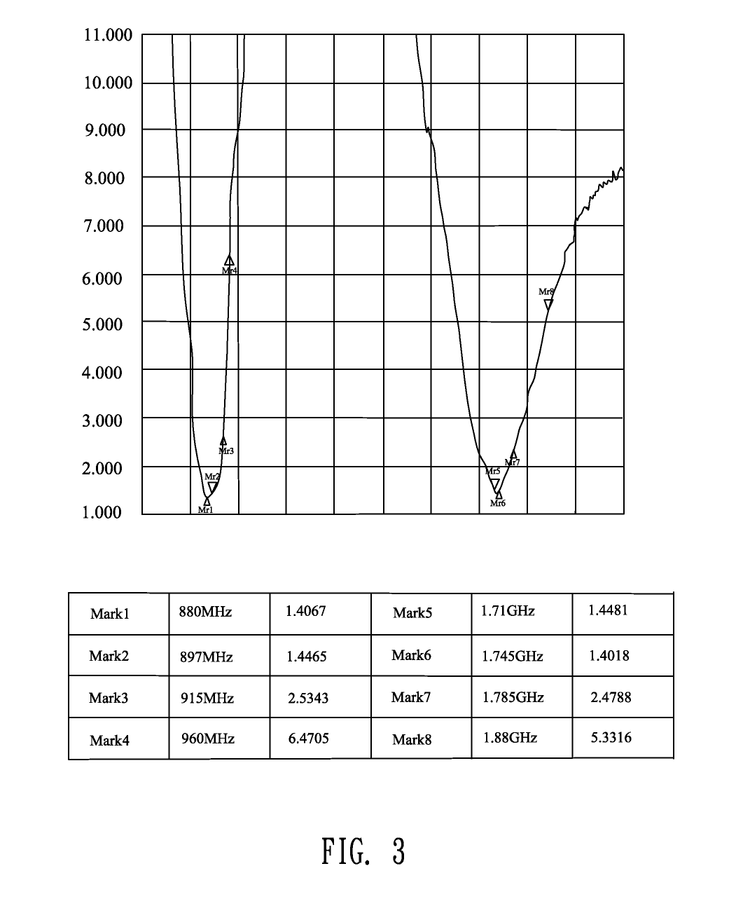

FIG. 3 shows a voltage standing wave ratio (VSWR) test chart of the antenna device 100 when the antenna device 100 operates at wireless communication. When the antenna device 100 operates at a frequency of 880 megahertz (MHz) (Mr1 in FIG. 3), the resulting VSWR value is 1.4067. When the antenna device 100 operates at a frequency of 897 MHz (Mr2 in FIG. 3), the resulting VSWR value is 1.4465. When the antenna device 100 operates at a frequency of 915 MHz (Mr3 in FIG. 3), the resulting VSWR value is 2.5343. When the antenna device 100 operates at a frequency of 960 MHz (Mr4 in FIG. 3), the resulting VSWR value is 6.4705. When the antenna device 100 operates at a frequency of 1.71 gigahertz (GHz) (Mr5 in FIG. 3), the resulting VSWR value is 1.4481. When the antenna device 100 operates at a frequency of 1.745 GHz (Mr6 in FIG. 3), the resulting VSWR value is 1.4018. When the antenna device 100 operates at a frequency of 1.785 GHz (Mr7 in FIG. 3), the resulting VSWR value is 2.4788. When the antenna device 100 operates at a frequency of 1.88 GHz (Mr8 in FIG. 3), the resulting VSWR value is 5.3316.

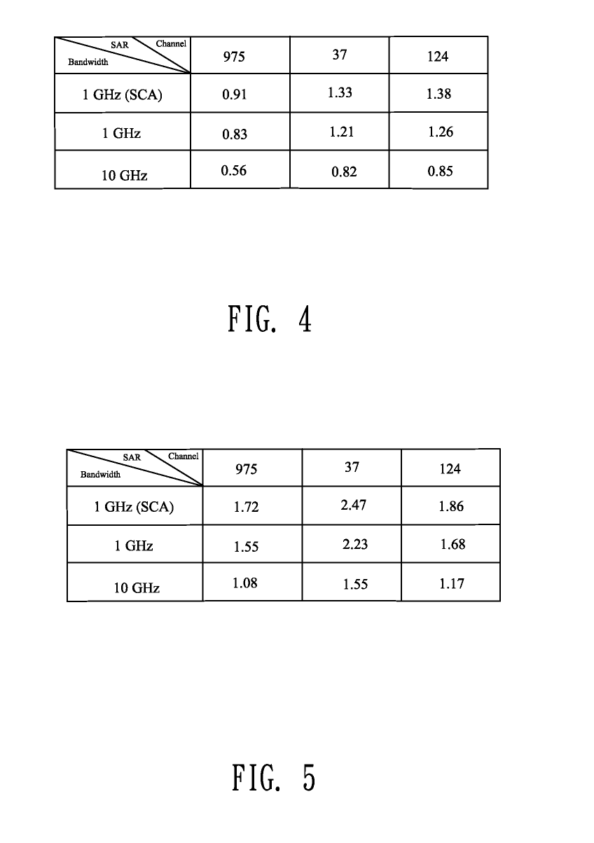

Please refer to FIG. 4, when the antenna device 100 operates at the channel 975 (about 880 MHz), the SAR value is 0.91 within the 1 GB (Gigabyte) bandwidth, under the condition of the single channel analysis (SCA), the SAR value is 0.83 within the 1 GB bandwidth, and the SAR value is 0.56 within the 10 GB bandwidth. When the antenna device 100 operates at the channel 37 (about 897 MHz), the SAR value is 1.33 within the 1 GB bandwidth, under the condition of the single channel analysis, the SAR value is 1.21 within the 1 GB bandwidth, and the SAR value is 0.82 within the 10 GB bandwidth. When the antenna device 100 operates at the channel 124 (about 914 MHz), the SAR value is 1.38 within the 1 GB bandwidth, under the condition of the single channel analysis, the SAR value is 1.26 within the 1 GB bandwidth, and the SAR value is 0.85 within the 10 GB bandwidth.

FIG. 5 is a table of the SAR values of a conventional antenna without the resonance element, for comparing with the antenna device 100. When the conventional antenna operates at the channel 975, the SAR value is 1.72 within the 1 GB bandwidth, under the condition of the single channel analysis, the SAR value is 1.55 within the 1 GB bandwidth, and the SAR value is 1.08 within the 10 GB bandwidth. When the conventional antenna operates at the channel 37, the SAR value is 2.47 within the 1 GB bandwidth, under the condition of the single channel analysis, the SAR value is 2.23 within the 1 GB bandwidth, and the SAR value is 1.55 within the 10 GB bandwidth. When the conventional antenna operates at the channel 124, the SAR value is 1.86 within the 1 GB bandwidth, under the condition of the single channel analysis, the SAR value is 1.68 within the 1 GB bandwidth, and the SAR value is 1.17 within the 10 GB bandwidth. Therefore, the SAR values of the antenna device 100 are lower than that of the conventional antenna. Especially, compared to the SAR values of the conventional antenna, the SAR values of the antenna device 100 are approximately cut in half at the channel 975 and the channel 37.

As described above, the antenna device 100 is capable of transmitting the signals from the frequency bands ranging from 880 MHz to 915 MHz, and 1710 MHz to 1785 MHz, and has an excellent performance of operation at wireless communication. Meanwhile, the antenna device 100 is provided with the simple resonance element 20. The resonance element 20 is capable of resonating with the signals from the frequency band ranging from 880 MHz to 915 MHz, which decreases the SAR values of the antenna device 100, consequently, reducing the harm to the users when the users use the portable electronic device.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An antenna device connected to a circuit board, comprising:
a main body comprising:
a first radiator having a first radiating portion, a third radiating portion abreast of the first radiating portion, an elongated second radiating portion connected with opposite ends of the first radiating portion and the third radiating portion to show a substantially door shape, a fourth radiating portion extended outwards from a side of the third radiating portion opposite to the second radiating portion, and a fifth radiating portion extended downwardly from a free end of the third radiating portion, and stretched towards the same side of the third radiating portion as the second radiating portion;
a second radiator of strip shape extended toward the third radiating portion from an end of the first radiating portion opposite to the second radiating portion, the second radiator extended beyond a free end of the fifth radiating portion and spaced from the third radiating portion and the fifth radiating portion;
a feeding portion and a grounding portion extended downwards from an end of a side of the second radiator opposite to the first radiating portion side by side, and away from the fifth radiating portion, for being connected with an antenna circuit and a grounding circuit of the circuit board, respectively; and
a resonance element having an elongated first resonating portion spaced from the main body with a predetermined distance, and a second resonating portion extended perpendicularly from an end of the first resonating portion away from the main body for being connected with the grounding circuit of the circuit board.

2. The antenna device as claimed in claim 1, wherein the first radiating portion, the second radiating portion, the third radiating portion, the fourth radiating portion and the second radiator are disposed at the same plane.

3. The antenna device as claimed in claim 1, wherein the fourth radiating portion is rectangular and extended outwardly from an end of the side of the third radiating portion away from the fifth radiating portion.

4. The antenna device as claimed in claim 1, further comprising a support laid on the circuit board, the main body being mounted to the support.

5. The antenna device as claimed in claim 4, wherein the first radiating portion, the second radiating portion, the third radiating portion, the fourth radiating portion and the second radiator are located on a top surface of the support, the fifth radiating portion is attached to a side of the support, the feeding portion and the grounding portion are disposed at the side of the support.

6. The antenna device as claimed in claim 5, wherein the support is located at an end of a top surface of the rectangular circuit board, the first resonating portion is disposed at a side of the top surface of the circuit board where the fourth radiating portion is located, and extends along the side of the circuit board, the second resonating portion is away from the fourth radiating portion with respect to the first resonating portion.
